(19) United States
(12) Patent Application Publication
(10) Pub. No.: US 2009/0106052 A1
(43) Pub. Date: Apr. 23, 2009

(54) COMPUTERIZED ACQUISITION AND COMPILATION OF VEHICLE ACCIDENT INFORMATION

(76) Inventor: Eytan Moldovan, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/876,558

(22) Filed: Oct. 22, 2007

(51) Int. Cl. G06Q 40/00; G06F 17/40; G06Q 99/00

(52) U.S. Cl. 705/4; 705/1; 705/39

(57) ABSTRACT

Vehicle accident information is collected at the scene of an accident utilizing a portable communication device having a user interface and a digital camera. A user loads an application onto the user interface of the portable communication device, displaying instructions for collecting accident information and instructs the user to record and input vehicle accident information to the application through the portable communications device that may also include digital images. The user may then transmit the accident information to a database where it is stored, may be edited by the user and forwarded to third parties.

### BACKGROUND

The present disclosure relates, in general, to motor vehicle accidents, and more particularly to systems and methods for documenting and recording issues relating to motor vehicle accidents at the scene.

The scene of an accident is a stressful place, there is shock and possibly injury or worse, leaving people involved feeling helpless and confused about what actions to take. Documentation of the circumstances of such accidents for insurance or legal purposes is typically inadequate being either incomplete or wrong due to the stress and confusion associated with such an event. It is, therefore, useful to provide a method in an easily accessible manner to enable the accurate recording of events associated with an accident and a speedy delivery of accident information to relevant parties. This can assist authorities, insurance agencies/companies, and the parties in resolving issues and possibly avoiding conflicting events as well as provide peace of mind to a user knowing that all relevant information has been collected and is in the possession of the relevant parties upon leaving the accident scene.

### SUMMARY

This disclosure is directed to provide a process that is useful, easy to use and has essential contents to effectively document accidents through a device carried by many individuals.

A method for recording vehicle accident information at the scene of an accident with a portable communication device is disclosed. A user loads an application onto a user interface of the portable communication device. The application displaying a set of instructions. The instructions at least include instructing a user to record: the damage done to the vehicles, driver license information, insurance information and vehicle registration information belonging to the driver(s) of the other vehicle(s) involved in the accident and inputting that information to a corresponding input field located on the application. Once the information has been gathered, the information is transmitted to a database where it is stored, retrievable by the user and forwarded to third parties such as insurance agencies/companies.

### DRAWINGS

The above-mentioned features and objects of the present disclosure will become more apparent with reference to the following description taken in conjunction with the accompanying drawings wherein like reference numerals denote like elements and in which:

FIG. 1 is a schematic showing one embodiment of the system for documenting and recording vehicle accident information.

FIG. 2 is a process flow operation diagram of one embodiment of the present disclosure.

FIG. 3 is another process flow operation diagram of one embodiment of the present disclosure.

FIG. 4 is an exemplary application page according to one embodiment of the present disclosure.

FIG. 5 is another exemplary application page according to one embodiment of the present disclosure.

FIG. 6 is another exemplary application page according to one embodiment of the present disclosure.

FIG. 7 is another schematic showing one embodiment of the system for documenting and recording vehicle accident information.

### DETAILED DESCRIPTION

The present disclosure is directed to a method for recording vehicle accident information and facilitating processing of vehicle insurance claims at an accident scene utilizing a portable communication device. Vehicle accidents described herein can include vehicles such as a motorcycle, a passenger car, a truck, a sport utility vehicle or any other vehicle bound to civil traffic laws.

The portable communication device as described herein has a user interface and a digital camera that is preferably integrated within the housing of the portable communication device, but may alternatively be separate. The portable communication device can be at least one of a cell phone, smartphone, personal digital assistant (PDA), electronic organizer or any other portable device capable of supporting a user interface able to browse the internet, a digital camera to capture digital images and an internal memory to store the digital images. An example of such a portable communications device maybe a Blackberry Pearl, a Palm Treo or a Motorola Q.

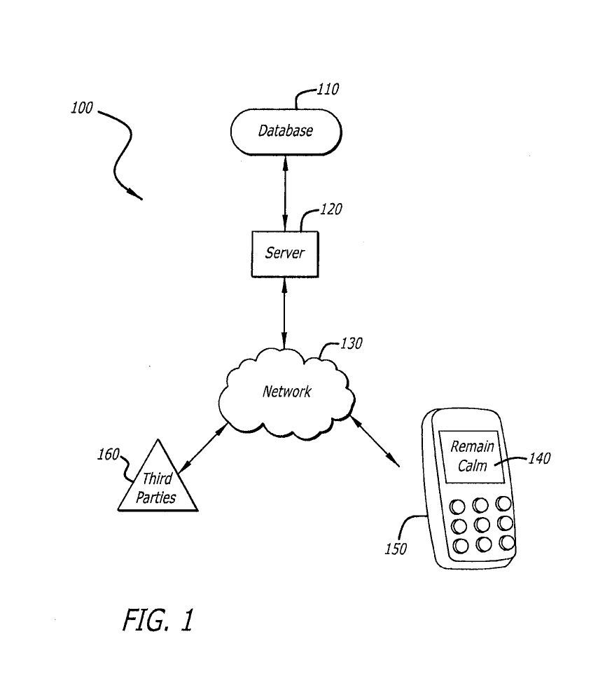

In one embodiment, FIG. 1 describes, a system 100. An application 140 is provided to a user interface of a portable communication device 150 for recording vehicle accident information therein, consisting of: a database 110, a server 120 connected through an internet network 130 with the portable communication device 150 and a plurality of third parties 160, wherein the third parties being at least an insurance agency or company, the Department of Motor Vehicles, the American Automobile Association or the other parties participant to the accident.

The application 140 described herein may be a web page associated with a web site or it may be a program stored within the memory of the portable communication device's internal memory or it may be a program stored within the server 120 accessible via the portable communication device 150.

In the event of an accident, a user at the accident scene begins by loading the application 140 from the server 120 onto the user interface of the portable communication device 150. The server 120 storing a computer program for assisting in the acquisition process of accident information. The computer program providing a application 140 with a set of instructions for collecting information at an accident scene.

In one aspect, the computer program may be provided within the portable communication device 150 and in communication with the server 120 for accessing and storing the accident information to the database 110.

Typical information sought at an accident scene includes driver's license information of the other driver(s) participant to the accident, their vehicle registration, insurance information, if the police were notified, if there were injuries or fatalities, where did the accident take place and what time of day did the accident occur. This information is what is required by either the insurance agencies/companies to process a claim or the Department of Motor Vehicles (DMV) for reporting accidents or both. In order to protect against false or exaggerated insurance claims, it is also helpful to have digital images of the damage done to vehicles participant in the accident.

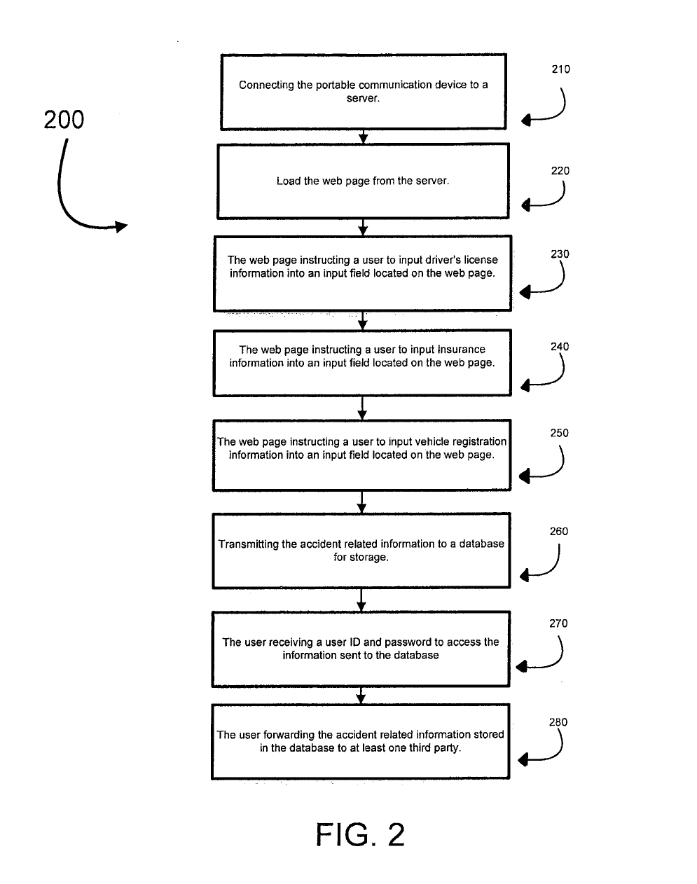

In one embodiment, process flow operations 200 for recording vehicle accident information are shown in FIG. 2. Operational flow begins in initialization operation 210 with a user initiating connection with the server 120 from the portable communications device 150.

In one aspect, initiating connection can be accomplished by dialing a number sequence in the same manner people dial 911 for emergency or 411 for information, they may dial, for example, 711 to be directly connected to the application 140.

In another aspect, the connection may be a link, icon or widget on the desktop of the user interface of the portable communication device 150 or simply a web address to type into a browser connecting the user to the application 140.

Connection established, control transfers to operation 220 loading the application 140 onto the user interface of the portable communication device 150. The application 140 displaying a plurality of instructions, walking the user through the accident information collection process. The collection process instructing the user step by step about what to do and what information should be collected, what photos are helpful and even calms the user with positive and soothing messages such as “Stay calm, we are here to guide you.” The application 140 may be a single application page that the user scrolls through after filling in each input field on the page 140 may consist of a plurality of individual instruction application pages that are linked together in a sequence.

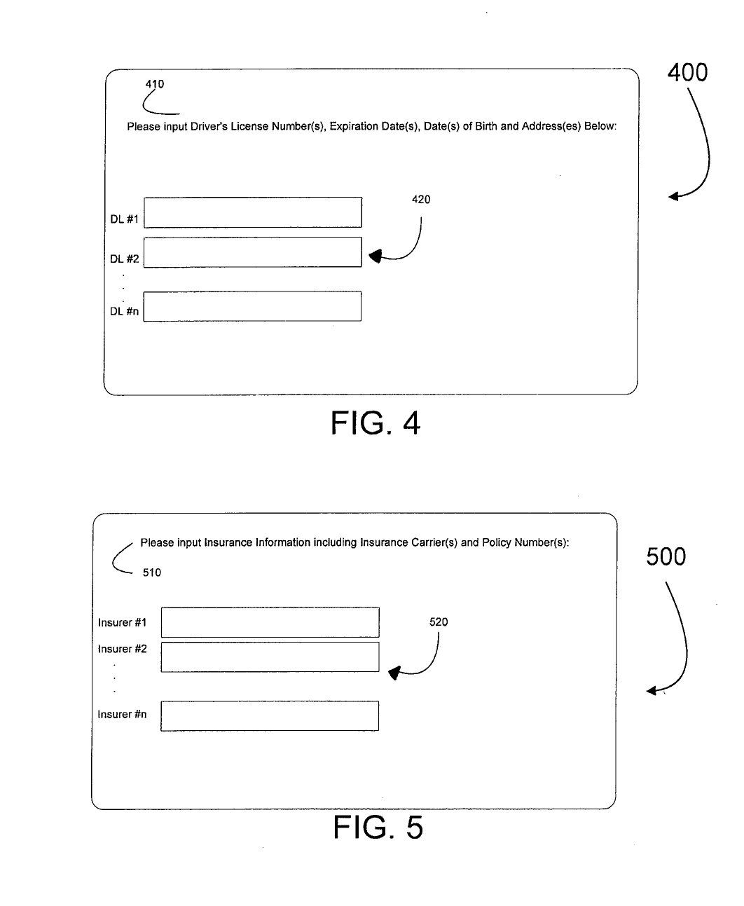

Control transfers to operation 230 instructing the user to input driver's license information to the corresponding input field(s) located on the application page 140. An exemplary embodiment of an individual driver's license instruction application page 400 is shown in FIG. 4, where instructions 410 instruct the user to provide name(s), driver license number(s), expiration date(s), birth date(s), phone number(s) and address(es) of the driver(s) involved in the accident and to input this information to the corresponding input fields 420.

Control transfers to operation 240 instructing the user to input insurance information to the corresponding input field(s) located on the application page 140. Insurance information may include the name of the insurance provider(s), policy number(s), expiration date(s) and what name(s) the policy is/are registered under. An exemplary embodiment of the individual insurance application page 500 is shown in FIG. 5, where the user is prompted with instructions 510 to provide insurance carrier and policy number information and to input this information into input field(s) 520 located on the application page.

Control transfers to Operation 250 instructing the user to provide vehicle registration information and to input this information to the corresponding input field located on the application page 140. The vehicle registration information may include the name(s) of the registered owner(s), address(es) of the registered owner(s), license plate number(s) make and model of the vehicle(s) and expiration date(s).

In one aspect, the user may be instructed to take a plurality of digital images of the damage done to the vehicle(s) involved in the accident and to upload the images to the application page 140. In this aspect the application page 140 may directly link with the functionality of the digital camera or the application may upload the digital images from a stored location within the portable communication device's 150 internal memory.

Other information that may be relevant to instruct the user to record may include: if the police were notified, if there were injuries or fatalities, where did the accident take place, what time of day did the accident occur and accident witness contact information.

Control transfers to operation 260, where the electronic instructions have concluded, the requested information has been inputted/uploaded to the application 140 and is ready to be sent to the database 110 for storage.

In one aspect, the user may be instructed to provide their personal information to send with the collected accident information. The user's information may include the same information sought of the other vehicle driver(s) participant to the accident. Once the accident information is sent to database 110, control transfers to operation 270.

In operation 270, the server automatically sends the user a reply, for example a text message or an email, when the vehicle accident information is received by the database 110. The reply from the server may include a user identification name and password to access the sent accident information from the database 110.

In another aspect, the operation 270 may not be necessary and the sent accident information may automatically tag the accident information with user identification information stored within the portable communications device, such as service provider account information. In this example, the user may be able to access the accident information from database 110 by typing in the name and account number of the service provider of their portable communication device 150.

Once in the database 110 the information can be reviewed, edited by the user and forwarded to third parties in operation 280. For example, the user might want to report that they were experiencing neck pains the day following the accident or to add further details in the form of comments that may have been lost in the stress of the moment. Furthermore, once stored in database 110 the user can have the information forwarded to at least one third party such as an insurance agency/company or the Department of Motor Vehicles. The database 110 may be accessed by either a personal computer from home or through the portable communication device 150.

In one embodiment, the process flow operations 200 may make use of voice recognition technology enabling the user to “talk” the accident information into the application through, for example, the receiver of a cell phone when prompted by the application pa 140.

In one embodiment, the process flow operations 200 may provided an option to the user to audibly “hear” the instructions through, for example, a speaker phone feature of the portable communication device 150. In this embodiment, the user may be prompted with the instructions audibly and may reply, inputting the accident information to the page 140, either in a manual fashion or by making use of the voice recognition capability and “talking” the accident information onto the application 140.

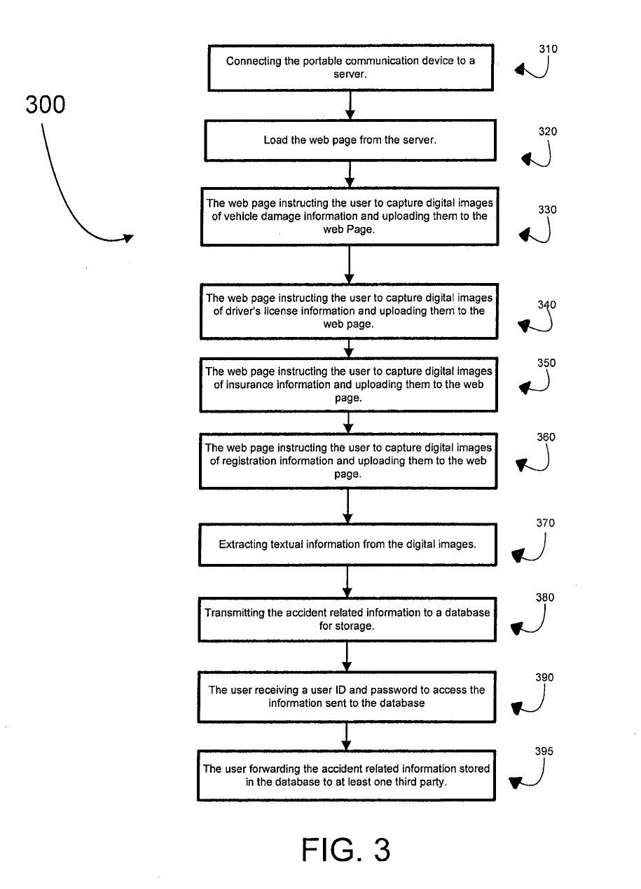

In one embodiment, process flow operations 300 are described in FIG. 3. Operational flow begins in initialization operation 310 with a user initiating connection with the server 120 from the portable communications device 150. Connection to the Server 120 may be accomplished in the same manner as described above for process flow operations 200.

Connection established, control transfers to operation 320 loading the application 140 onto the user interface of the portable communication device 150. The application 140 displaying a plurality of electronic instructions, walking the user through the accident information collection process and making use of all the same features and options as described above for process flow operations 200.

Control transfers to operation 330 instructing the user to take a plurality of digital images of the damage done to the vehicle(s) involved in the accident and to upload these images to the application 140. The application 140 may directly link with the functionality of the digital camera or the application may upload the digital images from a stored location within the portable communication device's internal memory.

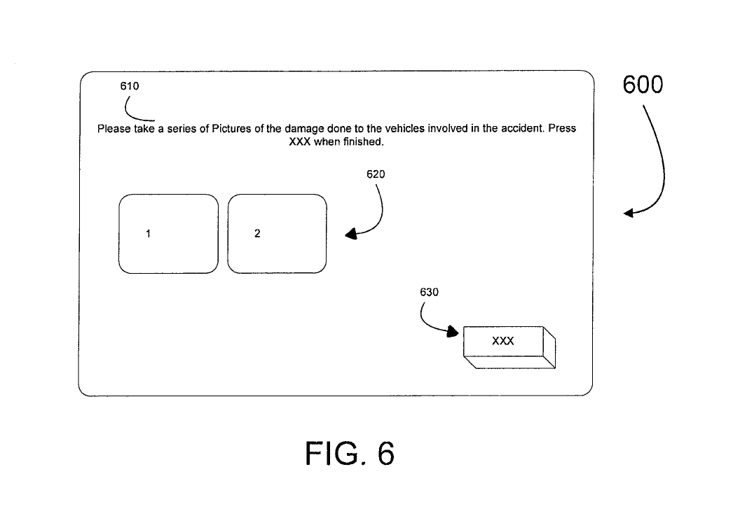

In an exemplary embodiment, shown in FIG. 6, illustrates an individual vehicle damage instruction application page 600. Application page 600 prompts the user with instructions 610 to take a plurality of digital images 620 of the damage done to vehicle(s) involved in the accident. In this example, the user has already taken two images 620 represented by 1 and 2. This exemplary embodiment also provides for a button XXX to “push” or “click” in order to navigate to the next individual instruction application page upon completing the current instruction.

Control transfers to operation 340 instructing the user to take a plurality of digital images of the driver's license(s) belonging to the other person(s) involved in the accident and to upload these digital images onto the application 140.

Control transfers to operation 350 instructing the user to take a plurality of digital images of the insurance information belonging to the other person(s) involved in the accident and to upload these digital images onto the application 140.

Control transfers to operation 360 instructing the user to take a plurality of digital images of vehicle registration information belonging to the other person(s) involved in the accident and to upload these digital images onto the application 140. When the electronic instructions have concluded and the requested digital images have been uploaded to the application 140, operational control transfers to operation 370.

In operation 370, textual information is extracted from the digital images by optical character recognition (OCR) software. The OCR software may be programmed with state driver's license and registration formats and insurance agencies/companies proof of insurance formats. The software may then analyze the uploaded digital images and search for key character sequences. Recognizing the format specific to, for example, a driver's license from California, the software may look for an eight character sequence, starting with one letter followed by seven numbers, and recognize that a character sequence fitting that description is the driver's license number. The software may be offered within the portable communication device 150 or it may be provided in the server 120.

In one aspect, to save internal memory of the portable communication device 150, the OCR software may be in the server 120. The user may then upload the captured digital images to the application 140 allowing the server 120 to analyze them, extract and classify the textual information as one of a driver's license, insurance or registration information.

In one aspect, the user may be instructed to provide their personal information to send with the collected accident information. The user's information may include a series of digital images such as those sought of the other vehicle driver(s) participant to the accident and the same extraction process may occur. After the extraction process is complete, control transfers to operation 380.

In operation 380, the server 120 sends the classified information to the database 110 along with the digital images of the vehicle damage in operation 380 for storage. Control transfers to operation 390.

In operation 390, the server 120 automatically sends the user a reply, for example a text message or an email, when the vehicle accident information is received by the database 110. The reply from the server may include a user identification name and password to be able to access the sent accident information from the database 110 in the same manner as described above for flow process 200 in FIG. 2.

Once stored in the database 110, the information can be reviewed, edited by the user and forwarded to third parties at operation 395. For example, the user might want to report that they were experiencing neck pains the day following the accident or to add further details in the form of comments that were lost in the stress of the moment.

The database 110 may be accessed by either a personal computer from home or through the portable communication device 150. Furthermore, once stored in database 110 the user can have the accident information forwarded to at least one third party such as an insurance agency/company in order to file an insurance claim or the Department of Motor Vehicles. Once the accident information has been sent to an insurance agency/company, the insurance agency/company may then send the accident to other third parties, such as other insurance agencies/companies in order to process a claim involving both agencies/companies.

In one embodiment, a number to call with an operator standing by to answer questions related to the instructions prompting the user on their portable communications device 150 or to help a user that may be having trouble with technical questions related to the application 140 or accessing information stored in the database 110.

In one aspect, a system administrator may provide software to run a process flow operation such as 200 and 300 free to use, but may charge a user a fee to access the information stored in the database 110. The system administrator may further charge a transactional fee every time a user sends the accident information to a third party. In another aspect, the system administrator may charge the third party the transactional fee. In another aspect, a third party, such as an insurance agency/company, may pay a monthly fee allowing it's clients to make use of the service without the client having to provide separate payment to the system.

In a further aspect, a service fee may be added to the monthly bill of the portable communication device. The service fee may be fixed and paid monthly or the system administrator may charge the portable communication device's service provider a service fee when utilized and that fee may be added to the monthly bill in the same manner as a fee is added for the purchase of, for example, a ringtone.

In another embodiment, a method for electronic acquisition and compilation of vehicle accident information by way of a portable communication device having a user interface is disclosed. The method comprises: initiating acquisition of accident information by loading an application to a user interface of a portable communication device, the application providing a user participant in a vehicle accident with a series of electronic instructions facilitating acquisition of accident information at an accident scene, the series of electronic instructions at least including: instructing the user to electronically input driver license information belonging to at least a driver of another vehicle participant to the accident to an input field provided by the application; instructing the user to electronically input insurance information belonging to at least the driver of another vehicle participant to the accident to an input field provided by the application; instructing the user to electronically input vehicle registration information belonging to at least the driver of another vehicle participant to the accident to an input field provided by the application; and transmitting the vehicle accident information to a database. In one aspect, the user is electronically instructed to take at least one digital image of damage done to at least one vehicle participant to the accident by way of a digital camera and uploading at least one digital image to the application. In another aspect, the driver license information includes at least one digital image taken by way of a digital camera and uploading at least one digital image to the application. In another aspect, the electronic instructions on the application are audible and the portable communication device is an integrated phone including a camera. In another aspect, wherein a voice recognition capability allows the user to input accident information by speaking. In another aspect, the method further comprises an insurance company uploading the accident information for processing a claim. In another aspect, the insurance company exchanges the accident information with one or more additional insurance companies. In another aspect, a fee payable to a system administrator is required prior to transmitting accident information in the database to third parties.

In another embodiment, a method for electronic acquisition and compilation of vehicle accident information by way of a portable communication device having a user interface and a digital camera is disclosed. The method comprises: initiating acquisition of accident information by loading an application to a user interface of a portable communication device, the application providing a user participant in a vehicle accident with a series of electronic instructions facilitating acquisition of accident information at an accident scene, the series of electronic instructions at least including: instructing the user to take at least one digital image of damage done to at least one vehicle participant to the accident and uploading the at least one digital image to the application; instructing the user to take at least one digital image of a driver's license belonging to at least a driver of another vehicle participant to the accident and uploading the at least one digital image to the application; instructing the user to take at least one digital image of insurance information belonging to at least the driver of another vehicle participant to the accident and uploading the at least one digital image to the application; instructing the user to take at least one digital image of vehicle registration information belonging to at least the driver of another vehicle participant to the accident and uploading the at least one digital image to the application; extracting textual information from the digital images; and transmitting the vehicle accident information to a database. In one aspect, the electronic instructions on the application are audible and the portable communication device is an integrated phone including a camera. In another aspect, the method further comprises an insurance company uploading the accident information for processing a claim. In another aspect, the insurance company exchanges the accident information with one or more additional insurance companies. In another aspect, a fee payable to a system administrator is required prior to transmitting accident information in the database to third parties.

In another embodiment, a method for electronically facilitating processing of a vehicle insurance claim relating to a vehicle accident is disclosed. The method comprises: loading an application to a user interface of a portable communication device, the application providing a user participant in a vehicle accident with a series of electronic instructions facilitating acquisition of vehicle accident information related to an insurance claim at an accident scene, the series of electronic instructions at least including: instructing the user to electronically input driver license information belonging to at least the driver of another vehicle participant to the accident to an input field provided by the application; instructing the user to electronically input insurance information belonging to at least the driver of another vehicle participant to the accident to an input field provided by the application; instructing the user to electronically input vehicle registration information belonging to at least the driver of another vehicle participant to the accident to an input field provided by the application; and transmitting the vehicle accident information related to the insurance claim to a database, such that an insurance company can upload the insurance claim information and process an insurance claim. In one aspect, the insurance company exchanges the claim information relating to the vehicle accident with one or more additional insurance companies. In another aspect, the user is electronically instructed to take at least one digital image of damage done to at least one vehicle participant to the accident by way of a digital camera and uploading at least one digital image to the application. In another aspect, the driver license information includes at least one digital image taken by way of a digital camera and uploading at least one digital image to the application. In another aspect, the user pays a fee to a system administrator for the transmission of claim information to at least one of an insurance company and third parties. In another aspect, the at least one of an insurance company and third parties pays a fee to a system administrator for each transmission of the claim information from the user. In another aspect, a fee payable to a system administrator is required prior to transmitting claim information in the database to third parties.

In one embodiment, a computer readable medium may connect the portable communication 140 device to a server 120, display the application 140 with instructions for the acquisition of the accident information on the user interface of the portable communication device 150, the instructions providing the user with a series of electronic instructions facilitating acquisition of the accident information at an accident scene.

The series of electronic instructions may at least include: instructing the user to input driver license information belonging to at least the driver of another vehicle participant to the accident to an input field on the application 140; instructing the user to input insurance information belonging to at least the driver of another vehicle participant to the accident to an input field on the application page 140; instructing the user to input vehicle registration information belonging to at least the driver of another vehicle participant to the accident to an input field on the application page 140; and transmitting the vehicle accident information to the database 110 where it can be edited and forwarded to at least one third party.

In one aspect, the medium may instruct the user to take at least one digital image of damage done to at least one vehicle participant to the accident by way of a digital camera and uploading the at least one digital image to the application 140.

In one aspect, the medium may instruct the user to also take at least one digital image of the driver's license of the driver of another vehicle participant to the accident taken by way of a digital camera and uploading at least one digital image to the application.

In one embodiment, a computer readable medium encoding a computer program connects the portable communication device 150 to a server 110; displays a application 140 with instructions for the acquisition of accident information on a user interface of the portable communication device 150, the instructions providing a user with a series of electronic instructions facilitating acquisition of accident information at an accident scene.

The series of electronic instructions at least including: instructing the user to take at least one digital image of at least one vehicle participant to the accident and uploading the at least one image to the application 140; instructing the user to take at least one digital image of the driver's license belonging to at least a driver of another vehicle participant to the accident and uploading the at least one image to the application 140; instructing the user to take at least one digital image of insurance information belonging to at least the driver of another vehicle participant to the accident and uploading the at least one image to the application 140; instructing the user to take at least one digital image of vehicle registration information belonging to at least the driver of another vehicle participant to the accident and uploading the at least one image to the application 140.

After requested information has been received, the medium extracts the textual information from the digital images and transmits the vehicle accident information to the database 110 where it can be edited and forwarded to at least one third party.

In one embodiment, a server 120, accessible by way of the portable communication device 150 through a network 130, operable to provide application information, including electronic instructions providing a user with a series of electronic instructions facilitating acquisition of vehicle accident information at an accident scene and input fields to input vehicle accident information to an application 140.

The application 140 operable to receive data from a portable communication device 150 having a user interface and a digital camera, the portable communication device 150 being operable by the user to access the application 140, capture digital images, upload the digital images to the application 140, input vehicle accident information to the application 140 and send the uploaded images and inputted vehicle accident information to the server 120.

The database 110, in communication with the server 120, to saves the vehicle accident information, wherein saved vehicle accident information is accessible to at least the user of the portable communication device 150.

The system 100 may make use of local caching software, such as Google Gears, to enable off-line access to services that normally only work on-line. It installs a database engine on the client system to locally cache the data. Google Gears-enabled applications use data from this local cache rather than from the online service. Using Google Gears, a web application may periodically synchronize the data in the local cache with an online service. If a network connection is not available, the synchronization is deferred until a network connection is established. Thus Google Gears enables web applications to work even though access to the network service is not present.

In one aspect, system 100 may use an optical character reader to extract textual information from digital images taken by the user of at least the driver's license, vehicle registration and insurance information belonging to at least the driver of another vehicle participant to the accident.

The system 100 may require the user to pay a fee to a system administrator each time accident information is sent to the at least one third party or the system may require the third party to pay the fee to the system administrator each time at least one third party receives accident information from the user. The system 100 may also require the user to pay a fee to access accident information after it is transmitted to the database 110.

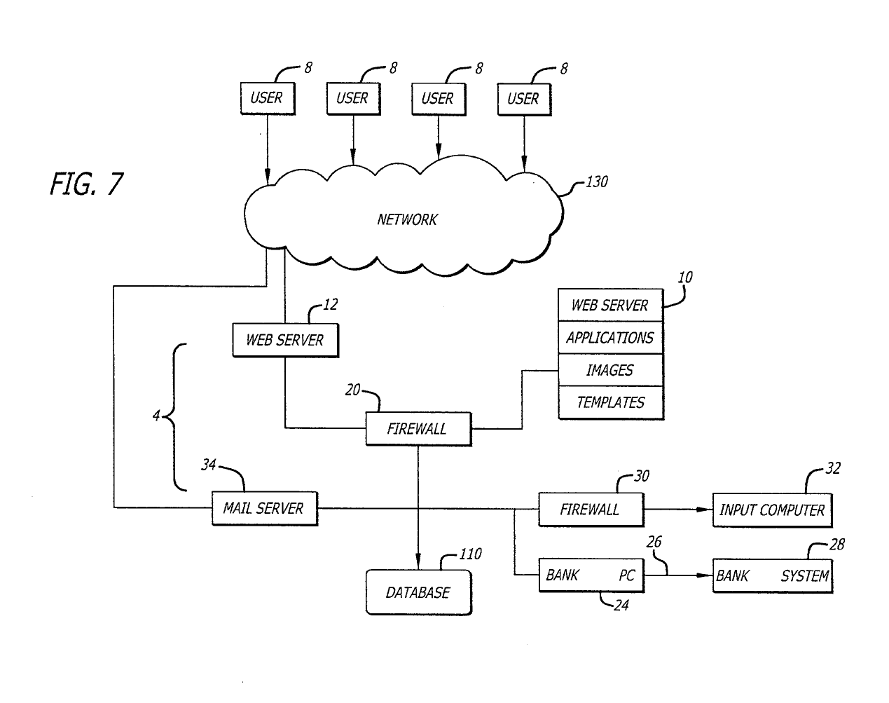

In one embodiment, FIG. 7 is an overview of a system to provide access to a database management system. With this system multiple users, for instance, remote users 8, access the application 140 through the network 130. Each of the users 8 has a portable communication device with the appropriate means for accessing network 140. The users 8 may be unknown to the server computers 10 and 12. Each user 8 is allowed to browse the application 140 and explore how the system functions.

There are several aspects to maintain security of information maintained in the database 110 and a banking system 28. A firewall 20 prevents any user 8 from accessing any of the components behind the firewall 20. In this way the users 8 have access to the server computers 10 and 12, but only have access to the database 110 through the firewall 20. The database 110 maintains, among other things, various database fields with respect to each of the accident profiles. The database 110 maintains the services with a designation associated to determine what accident information can be browsed by the users 8.

The server computers 10 and 12 can be identical and can be duplicated as additional load or growth on the system occurs. The server computers 10 and 12 share the responsibility for servicing the users of the application 140. This arrangement provides for expandability of the system by merely adding additional server computers as necessary.

The system includes an appropriate computer terminal 24 for interfacing with independent financial institutions which are connected on-line via the serial connection 26 to the financial institution computers 28. This allows automatic real time confirmation of the access of the accident information service. Once a user requires access to the service, the user goes through an identification or registration process and the exchange of financial information to allow for credit or debit card payment of the purchase. This is verified, confirmed and authorized by the appropriate bank system institution 28. Confirmation of the purchase or deposit of data, or a service is made by a mail server 34 which sends an E-mail or a text message to the user 8 confirming the purchase or deposit. The mail server 34 allows for mail to be received and sent out. Security of the various databases is maintained. Alert messages are generated when an unauthorized access is attempted. Verification messages, authorization messages and confirmation messages are generated as appropriate.

The database 110 is also designed to interact with an input computer 32 operated by a system administrator. A firewall 30 serves to prevent unauthorized access to the database 110 or to the input computer 32. The input computer 32 can input accident information to the database 110, after appropriate access and/or passwords are entered into the system. Similarly, users 8 through their own computers or portable communication device's can use appropriate access codes and passwords to access input data to the database 110. This is tightly controlled for security reasons. The data may only be added to an independent sub-database of the database 110, and only after scrutiny by the system administrator of the database 110 through input computer 32, will this data from users 8 be subsequently added to the main database 110.

Although functional components, devices, software elements, hardware elements, and features and functions described herein maybe depicted or described as being fixed in software or hardware or otherwise, it will be recognized by persons of skill in the art that the features and functions described herein maybe implemented in various software, hardware and/or firmware combinations and that the functions described herein may be distributed into various components or subcomponents on the network and are not fixed to any one particular component as described herein. Thus the databases described may be separated, unified, federated, or otherwise structured to best suit the preferences of the implementer of the features and functions described herein.

While the system and method have been described in terms of what are presently considered to be the most practical and preferred embodiments, it is to be understood that the disclosure need not be limited to the disclosed embodiments. It is intended to cover various modifications, similar arrangements and sequence combinations of information presented included within the spirit and scope of the claims, the scope of which should be accorded the broadest interpretation so as to encompass all such modifications and similar structures. The present disclosure includes any and all embodiments of the following claims.

1. A method for electronic acquisition and compilation of vehicle accident information by way of a portable communication device having a user interface, the method comprising:
using an non-dedicated portable communications device having a user interface and an integrated digital camera, the device being normally unconnected to a server;
initiating a connection to the server with the portable communication device at a scene of a vehicle accident after an occurrence of an accident, wherein the server is remote from the scene of the vehicle accident;
loading a software application stored on the server to the user interface of a portable communication device after the connection has been established, the software application sequentially prompting a user participant in a vehicle accident with a series of electronic instructions facilitating acquisition of accident information at an accident scene, the series of electronic instructions at least including:
instructing the user to electronically input driver license information belonging to at least a driver of another vehicle participant to the accident to an input field provided by the software application;
instructing the user to electronically input insurance information belonging to at least the driver of another vehicle participant to the accident to an input field provided by the software application;
instructing the user to electronically input vehicle registration information belonging to at least the driver of another vehicle participant to the accident to an input field provided by the software application;
wherein the series of electronic instructions are not limited to a particular order; and
transmitting the vehicle accident information to the server for storage in a database associated with the server.

2. The method of claim 1, wherein the user is electronically instructed to take at least one digital image of damage done to at least one vehicle participant to the accident by way of a digital camera and uploading at least one digital image to the application.

3. The method of claim 1, wherein the driver license information includes at least one digital image taken by way of a digital camera and uploading at least one digital image to the application.

4. The method of claim 1, wherein the electronic instructions on the application are audible and the portable communication device is an integrated phone including a camera and wherein a voice recognition capability allows the user to input accident information by speaking.

5. (canceled)

6. The method of claim 1, further comprising an insurance company uploading the accident information for processing a claim.

7-8. (canceled)

9. A method for electronic acquisition and compilation of vehicle accident information by way of a portable communication device having a user interface and a digital camera, the method comprising:
initiating acquisition of accident information by loading a software application stored on a server remote from the accident scene to a user interface of a non-dedicated portable communication device, the software application providing a user participant in a vehicle accident with a series of electronic instructions facilitating acquisition of accident information at an accident scene, the series of electronic instructions at least including:
instructing the user to take at least one digital image of damage done to at least one vehicle participant to the accident and uploading the at least one digital image to the software application;
instructing the user to take at least one digital image of a driver's license belonging to at least a driver of another vehicle participant to the accident and uploading the at least one digital image to the software application;
instructing the user to take at least one digital image of insurance information belonging to at least the driver of another vehicle participant to the accident and uploading the at least one digital image to the software application;
instructing the user to take at least one digital image of vehicle registration information belonging to at least the driver of another vehicle participant to the accident and uploading the at least one digital image to the software application;
wherein the series of electronic instructions are not limited to a particular order;
transmitting the vehicle accident information to a server;
extracting textual information from the digital images via optical character reader software; and
storing the extracted textual information in a database.

10. The method of claim 9, wherein the electronic instructions on the application are audible and the portable communication device is an integrated phone including a camera.

11. The method of claim 9, further comprising an insurance company uploading the accident information for processing a claim.

12. The method of claim 11, wherein the insurance company exchanges the accident information with one or more additional insurance companies.

13. The method of claim 9, wherein a fee payable to a system administrator is required prior to transmitting accident information in the database to third parties.

14-20. (canceled)

21. The method of claim 9, further comprising generating a reply to the user participant in the vehicle accident by the server that is in communication with the database, wherein the reply at least includes a user ID to access the vehicle accident information in the database.

22. The method of claim 1, further comprising generating a reply to the user participant in the vehicle accident by the server that is in communication with the database, wherein the reply at least includes a user ID to access the vehicle accident information in the database.

23. The method of claim 9, further comprising instructing the user to provide personal information after collecting the vehicle accident information, wherein the personal information allows the user to access the vehicle accident information stored in the database by providing the personal information at a login screen.

24. The method of claim 1, further comprising instructing the user to provide personal information after collecting the vehicle accident information, wherein the personal information allows the user to access the vehicle accident information stored in the database by providing the personal information at a login screen.

25. The method of claim 9, wherein the server in communication with the database tags the vehicle accident information as the vehicle accident information is received in the database with a user identification, wherein the user identification is stored within the portable communication device, and wherein the identification stored within the portable communication device allows the user to access the information transmitted to the database.

26. The method of claim 1, wherein the server in communication with the database tags the vehicle accident information as the vehicle accident information is received in the database with a user identification, wherein the user identification is stored within the portable communication device, and wherein the identification stored within the portable communication device allows the user to access the information transmitted to the database.

27. The method of claim 1, wherein connection to the server from the portable communication device is initiated by selecting one from the group of a web link, a desktop icon or a desktop widget.

28. The method of claim 1, wherein connection to the server from the portable communication device is initiated by dialing a number.

29. A method of adapting a telephone having functionality essentially unassociated with acquiring and compiling vehicle accident information to a device for electronic acquisition and compilation of vehicle accident information at the scene of an accident, the method comprising:
using a portable telephone having a user interface and an integrated digital camera, the telephone being normally unconnected to a server and having functionality essentially unassociated with acquiring and compiling vehicle accident information;
initiating a connection to the server with the portable telephone at a scene of a vehicle accident after an occurrence of an accident, wherein the server is remote from the scene of the vehicle accident;
loading a software application stored on the server to the user interface of the portable telephone after the connection has been established, the software application sequentially prompting a user participant in a vehicle accident with a series of electronic instructions facilitating acquisition of accident information at an accident scene, the series of electronic instructions at least including:
instructing the user to electronically input driver license information belonging to at least a driver of another vehicle participant to the accident to an input field provided by the software application;
instructing the user to take at least one digital image of the driver license via the integrated digital camera of the portable telephone and to upload the at least one digital image to the software application;
instructing the user to electronically input insurance information belonging to at least the driver of another vehicle participant to the accident to an input field provided by the software application;
instructing the user to electronically input vehicle registration information belonging to at least the driver of another vehicle participant to the accident to an input field provided by the software application;
instructing the user to take at least one digital image of damage to at least one vehicle participant to the accident and uploading the at least one digital image to the software application;
wherein the series of electronic instructions are not limited to a particular order;
transmitting the vehicle accident information to the server for storage in a database associated with the server; and
wherein the server automatically sends the user a reply when the vehicle accident information has been stored in the database, wherein the reply is in a form of a text message or an email and wherein after the vehicle accident information is stored in the database, the vehicle accident information is accessible by the user.
